(19) United States
(12) Patent Application Publication
(10) Pub. No.: US 2026/0065893 A1
(43) Pub. Date: Mar. 5, 2026

(54) METHOD OF TEXT-TO-SPEECH, MEDIUM, AND ELECTRONIC DEVICE

(71) Applicant: Beijing Zitiao Network Technology Co., Ltd., Beijing (CN)

(72) Inventors: Yu CHEN, Beijing (CN); Hongxu XU, Beijing (CN)

(21) Appl. No.: 19/307,762

(22) Filed: Aug. 22, 2025

(30) Foreign Application Priority Data
Aug. 30, 2024 (CN) 202411218045.6

(51) Int. Cl. G10L 13/047; G10L 15/00

(52) U.S. Cl. CPC G10L 13/047; G10L 15/005

(57) ABSTRACT

The present disclosure relates to a method of text-to-speech, a medium, and an electronic device, and the method includes: obtaining chat content, where the chat content includes a first text and a second text output by a dialogue model for the first text, and the second text includes text organized in sequence number; identifying, according to the first text and the second text, a target language for playing the sequence number in speech form; and playing the sequence number in speech form with the target language.

### CROSS-REFERENCE TO RELATED APPLICATION(S)

The present application claims the priority of the Chinese patent application 202411218045.6 filed on Aug. 30, 2024, the entire contents of which are hereby incorporated by reference as a part of the present application.

### TECHNICAL FIELD

The present disclosure relates to the field of electronic information technology, and particularly, to a method of text-to-speech, an apparatus, a medium, an electronic device, and a program product.

### BACKGROUND

In large model-based dialogue scenarios, outputting text organized in sequence number is a common scenario.

Currently, in the large model-based dialogue scenario, it is supported to play text in the form of speech, and when playing text organized in sequence number in the form of speech, it is necessary to determine in which language the sequence number will be played.

### SUMMARY

This Summary is provided to introduce concepts in a simplified form that are described in detail in the following Detailed Description section. This Summary section is not intended to identify key features or essential features of the claimed technical solution, nor is it intended to be used to limit the scope of the claimed technical solution.

In a first aspect, the present disclosure provides a method of text-to-speech, including: obtaining chat content, where the chat content includes a first text and a second text output by a dialogue model for the first text, and the second text includes text organized in sequence number; identifying, according to the first text and the second text, a target language for playing the sequence number in speech form; and playing the sequence number in speech form with the target language.

In a second aspect, the present disclosure provides a text-to-speech apparatus, including:
an obtaining module configured to obtain chat content, where the chat content includes a first text and a second text output by a dialogue model for the first text, and the second text includes text organized in sequence number;
an identification module configured to identify, according to the first text and the second text, a target language for playing the sequence number in speech form; and
a playback module configured to play the sequence number in speech form with the target language.

In a third aspect, the present disclosure provides a computer-readable medium storing a computer program, where the computer program, when executed by a processing apparatus, implements steps of the method of the first aspect.

In a fourth aspect, the present disclosure provides an electronic device, including:
a storage apparatus storing a computer program;
a processing apparatus configured to performing the computer program in the storage apparatus to implement steps of the method of the first aspect.

In a fifth aspect, the present disclosure provides a computer program product including a computer program, where the computer program, when executed by a processor, implements steps of the method of the first aspect.

According to the above technical solution, language identification is performed according to the first text and the second text to obtain the target language for playing the sequence number in the speech form, that is, the influence of the first text and the second text in the chat content on the language used to play the sequence number in speech form is simultaneously considered, and the accuracy and reliability of the language used to play the sequence number in speech form are improved.

Other features and advantages of the present disclosure will be described in detail in the following Detailed Description section.

### BRIEF DESCRIPTION OF DRAWINGS

The above and other features, advantages, and aspects of various embodiments of the present disclosure will become more apparent when taken in conjunction with the accompanying drawings and with reference to the following Detailed Description. Throughout the drawings, the same or similar reference numbers refer the same or similar elements. It should be understood that the drawings are schematic and that the components and elements are not necessarily drawn to scale. In the drawings:

FIG. 1 is a flowchart of a method of text-to-speech according to an exemplary embodiment of the present disclosure.

FIG. 2 is a process diagram of a voting operation according to an exemplary embodiment of the present disclosure.

FIG. 3 is a block diagram of a text-to-speech apparatus according to an exemplary embodiment of the present disclosure.

FIG. 4 is a schematic structural diagram of an electronic device according to an exemplary embodiment of the present disclosure.

### DETAILED DESCRIPTION

Embodiments of the present disclosure will be described in more detail below with reference to the drawings. Although some embodiments of the present disclosure are shown in the drawings, it should be understood that the present disclosure can be implemented in various forms and should not be construed as being limited to the embodiments set forth herein. Rather, these embodiments are provided for a thorough and complete understanding of the present disclosure. It should be understood that the drawings and embodiments of the present disclosure are only for exemplary purposes, and are not intended to limit the scope of the present disclosure.

It should be understood that various steps described in method implementations of the present disclosure can be performed in different orders, and/or performed in parallel. In addition, the method implementations can include additional steps and/or omit performing the illustrated steps. The scope of the present disclosure is not limited in this respect.

The term “include/comprise” used herein and the variations thereof are open-ended inclusions, namely, “include/comprise but not limited to”. The term “based on” is “at least partially based on”. The term “one embodiment” means “at least one embodiment”; the term “another embodiment” means “at least one other embodiment”; and the term “some embodiments” means “at least some embodiments”. Relevant definitions of other terms will be given in the description below.

It should be noted that concepts such as “first” and “second” mentioned in the present disclosure are only used to distinguish different apparatuses, modules, or units, and are not used to limit the order of functions performed by these apparatuses, modules, or units or interdependence between these apparatuses, modules, or units.

It should be noted that the modifications of “one” and “a plurality” mentioned in the present disclosure are illustrative rather than restrictive, and those skilled in the art should understand that unless the context clearly indicates otherwise, the modifications should be understood as “one or more”.

The names of messages or information exchanged between a plurality of apparatuses in the implementations of the present disclosure are only for illustrative purposes, and are not intended to limit the scope of these messages or information.

It should be understood that before using the technical solutions disclosed in the embodiments of the present disclosure, the user should be informed of the type, scope of use, use scenario, etc. of the personal information involved in the present disclosure in accordance with relevant laws and regulations in an appropriate manner, and the user's authorization should be obtained.

For example, in response to receiving a proactively request from a user, prompting information is sent to the user to explicitly prompt the user that the requested operation will require access to and use of the user's personal information. Thereby, the user is enabled to independently choose whether or not to provide the personal information to software or hardware, such as an electronic device, an application, a server, or a storage medium, that performs the operation of the technical solution of the present disclosure based on the prompting information.

As an optional but non-limiting realization, in response to receiving a proactively request from the user, the manner of sending the prompting information to the user may be, for example, a pop-up window, in which the prompting information may be presented in the form of text. In addition, the pop-up window may contain an option control for the user to select “agree” or “disagree” to provide the personal information to the electronic device.

It should be understood that the above notification and user authorization process is only schematic, and does not limit the implementation of the present disclosure, and other ways to meet the relevant laws and regulations may also be applied to the implementation of the present disclosure.

It is understood that the data involved in the present technical solution (including but not limited to the data itself, the acquisition or use of the data) should comply with the requirements of the corresponding laws and regulations and relevant provisions.

In the large model-based dialogue scenario, at least playback of the text output by large model in the form of speech is supported, while when playing text organized in sequence number, it is necessary to determine in which language the sequence number is played.

In the related art, language identification is performed only based on the text output by large model to obtain the language sampled when playing the corresponding sequence number, and this method is usually difficult to accurately determine when the input information of the large model and the text output by the large model for the input information involve language information of a plurality of language. For example, chat:

First text: “ [symbol] , [symbol] ” (which means “introduce three types of fruit, with the introduction part in English” in English).

The second text: “ [symbol] (which means “here are three kinds of fruits for you” in English):
1. Apple ( [symbol] (which means “apple” in English))
Apples are a globally popular fruit known for their round shape, smooth skin, and sweet to tart taste;
2. Banana ( [symbol] (which means “banana” in English))
Bananas are elongated, curved fruits that are typically eaten raw;
3. Oranges ( [symbol] (which means “oranges” in English)
Oranges are a type of citrus fruit known for their vibrant orange color and sweet, tangy flavor.”

In the above chat, both the second text and the first text involve Chinese and English language information, and it is not possible to accurately determine whether sequence number “1” should be read aloud in Chinese or English based on the second text alone.

In view of this, how to correctly play sequence number in the form of speech is an urgent technical problem to be solved.

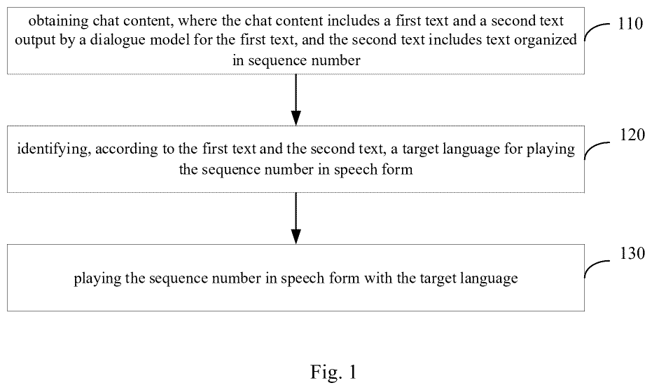

FIG. 1 is a flowchart of a method of text-to-speech according to an exemplary embodiment of the present disclosure, the method of text-to-speech may be applied to electronic device, and the method of text-to-speech may be executed by a text-to-speech apparatus, where the text-to-speech apparatus may be implemented by software and/or hardware and may be configured in electronic device. Referring to FIG. 1, the method of the text-to-speech may include the following steps:

Step 110: obtaining chat content, where the chat content includes a first text and a second text output by a dialogue model for the first text, and the second text includes text organized in sequence number.

The first text may refer to text input by the user to the dialogue model, or may be text obtained by converting speech input by the user to the dialogue model.

The dialogue model may be a dialogue model based on Large Language Model (LLM), and the dialogue model may receive a first text, then perform text understanding on the first text, and output a second text given for the first text.

The sequence number may refer to sequence number representing the order, such as the number sequence number and the Roman number sequence number.

Step 120: identifying, according to the first text and the second text, a target language for playing the sequence number in speech form.

It should be noted that hereinafter, the target language of the sequence number is understood to be the language used when playing the sequence number in speech form.

The dialogue model may have the function of language identification to realize the identification of the target language used to play the sequence number; In other embodiments, other trained language identification model may also be used to implement language identification.

In the present embodiment, language identification may be performed according to the first text and the second text, respectively, to obtain the corresponding language identification result, and then all language identification results may be integrated to determine the target language of the sequence number. For example, the above step 120 may be implemented by: performing language identification according to the first text to obtain a first language identification result of the sequence number; performing language identification according to the second text to obtain a second language identification result of the sequence number; and performing a voting operation on language identification results of the sequence number according to the first language identification result and the second language identification result to obtain the target language for playing the sequence number in speech form. Regarding the embodiment of language identification and the embodiment of determining the target language based on the language identification result, the following related embodiments may be referred to, and the present embodiment will not be repeatedly described here.

Step 130: playing the sequence number in speech form with the target language.

It should be understood that the present embodiment may simultaneously realize playing other contents in the second text other than the sequence number in the form of speech.

According to the above technical solution, language identification is performed according to the first text and the second text to obtain the target language for playing the sequence number in the speech form, that is, the influence of the first text and the second text in the chat content on the language used to play the sequence number in speech form is simultaneously considered, and the accuracy and reliability of the language used to play the sequence number in speech form are improved.

In some embodiments, the above step of performing language identification according to the first text to obtain the first language identification result of the sequence number may be implemented in the following ways: performing language identification according to target information of the first text to obtain the first language identification result of the sequence number, where the target information includes language information and/or semantic information.

The language information of the first text is the language adopted by the first text. For example, if the first text is “ [symbol] , [symbol] ”, its corresponding language information is Chinese. If the first text is “Introduce three types of fruit, with the introduction part in English”, its corresponding language information is English. When performing language identification according to language information, the language information of the first text may be determined as the first language identification result of the sequence number. Following the above example, the first text is “ [symbol] , [symbol] ”, and its corresponding language information is Chinese, that is, the first language identification result of the sequence number is Chinese.

The semantic information of the first text is obtained by text understanding based on the text content of the first text. The semantic information of the first text may be characterized as the language involved in the semantics of the first text, and when semantic information is used for language identification, the semantic information of the first text is determined as the first language identification result of the sequence number. Following the above example, the first text is “ [symbol] , [symbol] ”, and the corresponding semantic information includes introducing the introduction part in English, so the first language identification result of the sequence number may be English.

The language information and the semantic information of the first text may be both used for language identification, and the first language identification result may be determined by setting the priority of different target information, where the priority may be set based on the actual situation. For example, the priority of the language information may be set to be greater than the priority of the semantic information, that is, prioritize using language recognition result determined based on language information as the first language recognition result. For example, continuing with the above example, the first text is “ [symbol] , [symbol] ”, the language identification result determined based on the language information is Chinese, and the language identification result determined based on the semantic information is English, and because the priority of the language information is set to be greater than the priority of the semantic information, the language identification result determined based on the language information may be adopted as the first language identification result in the present embodiment.

It should be noted that in the first language identification result, besides being a certain type of language, the first language identification result may also be undecidable. For example, in a case where the first text is a formula, and because the formula cannot be understood as a language, in this case, the first language identification result is undecidable.

In the above manner, the language information and/or the semantic information of the first text is used to determine the first language identification result of the sequence number.

In some embodiments, the second language identification result includes a first sub-language identification result and a second sub-language identification result, and the step of performing language identification according to the second text to obtain a second language identification result of the sequence number may be implemented in the following ways: performing language identification according to context before a first sequence number in the second text to obtain the first sub-language identification result of the sequence number; and performing language identification according to context after the first sequence number in the second text to obtain the second sub-language identification result of the sequence number.

It should be noted that the first sequence number in the embodiment refers to the first one of sequence numbers in the text organized in sequence number.

When performing language identification based on the context of the first sequence number, language adopted by context is determined as the corresponding sub-language identification result. Following the above example, the second text is ““ [symbol] :1. Apple ( [symbol] ) Apples are a globally popular fruit known for their round shape, smooth skin, and sweet to tart taste . . . ”, The context before the first sequence number is “ [symbol] ”, and its language is Chinese. Therefore, the first sub-language identification result of the sequence number is Chinese. The context after the first sequence number is “Apple ( [symbol] ) Apples are a globally popular fruit known for their round shape”, the language adopted is English, so the second sub-language identification result of the sequence number is English.

Similar to the first language identification result, the first sub-language identification result and the second sub-language identification result may also be undecidable.

In the above manner, context of the second text is used to determine the corresponding sub-language identification result, thereby realizing the identification of the language corresponding to the sequence number.

Furthermore, it should be understood that the first sequence number in the text organized in sequence number may be serve as a transitional element that links the previous and subsequent content, and it is necessary to maintain the consistency of the reading of the sequence numbers in the large model scenario, so it is possible to use only the context of the first sequence number to determine the language, thereby reducing the amount of calculation in language identification.

From the above, it can be seen that the language identification result of the sequence number may include candidate language or undecidable, where the candidate language is a certain type of language, such as Chinese or English, and undecidable means that the language cannot be identified. It should be understood that the language identification results in the embodiment include the first language identification result, the first sub-language identification result, and the second sub-language identification result. The following is illustrated in connection with the voting operation of the first language identification result, the first sub-language identification result and the second sub-language identification result to obtain the target language of the sequence number.

First, in some embodiments, the above step of performing a voting operation on language identification results of the sequence number according to the first language identification result and the second language identification result to obtain the target language for playing the sequence number in speech form may be implemented in the following ways: performing the voting operation on language identification results of the sequence number according to the first language identification result, the first sub-language identification result and the second sub-language identification result to obtain a voting result; and when a vote count of a candidate language in the voting result is greater than or equal to a preset number of votes, determining the candidate language as the target language for playing the sequence number in speech form.

The preset number of votes may be set according to the total number of votes in the voting result, and as an example, the preset number of votes may be an integer value higher than half of the total number of votes. For example, in the present embodiment, the first language identification result, the first sub-language identification result, and the second sub-language identification result have a total of three votes, and therefore, the preset number of votes may be set to 2.

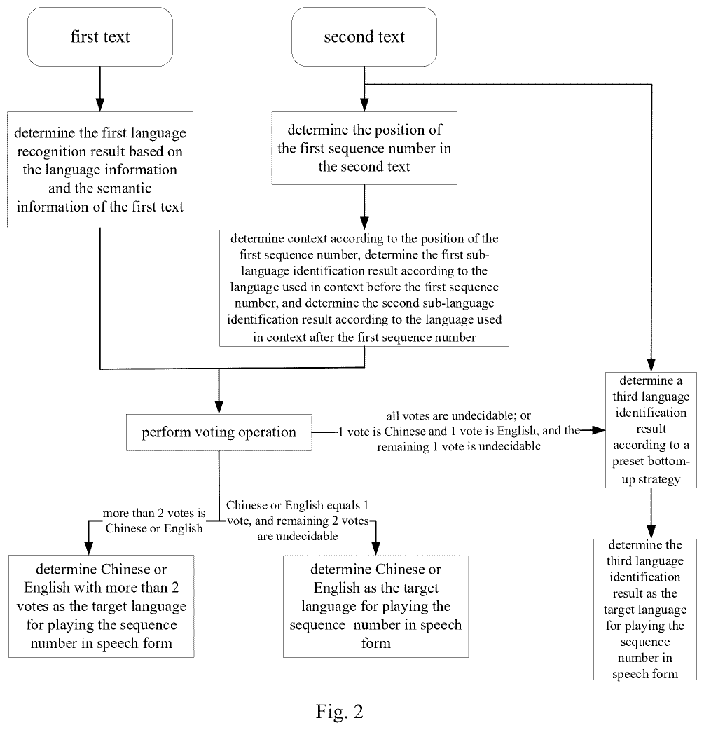

FIG. 2 is a process diagram of a voting operation according to an exemplary embodiment of the present disclosure. In this figure, the voting operation is illustrated by taking the candidate language in Chinese or English as an example. Referring to FIG. 2, when Chinese or English votes are greater than 2, that is, when the number of votes of the same candidate language is greater than or equal to the preset number of votes, the candidate language may be determined as the target language for playing the sequence number in speech form, that is, Chinese or English with more than 2 votes may be determined as the target language of the sequence number.

In some embodiments, the step of performing a voting operation on language identification results of the sequence number according to the first language identification result and the second language identification result to obtain the target language for playing the sequence number in speech form may further include the step: when only one vote in the voting result is the candidate language and all other votes are undecidable, determining the candidate language as the target language for playing the sequence number in speech form.

Continuing to refer to FIG. 2, the number of votes of Chinese or English is equal to one, and the remaining two votes are undecidable, that is, only one vote in the voting result is candidate language, and the other votes are undecidable, it may be determined that the candidate language is the target language for playing the sequence number in the form of speech, and it should be understood that the candidate language is English or Chinese determined based on language identification.

In some embodiments, the step of performing a voting operation on language identification results of the sequence number according to the first language identification result and the second language identification result to obtain the target language for playing the sequence number in speech form may further include the step: when the voting result satisfies a preset condition, determining a third language identification result determined according to a preset bottom-up strategy as the target language for playing the sequence number in speech form, where the preset condition includes that all votes in the voting result are undecidable or votes in the voting result are different from each other.

The preset bottom-up strategy may determine the third language identification result based on the second text. As an example, determining the third language identification result based on the second text and according to the preset bottom-up strategy may be implemented in the following ways: determining a position of the first sequence number in the second text, determining context according to the position of the first sequence number, and determining the third language identification result according to the language adopted by the context. Here, the embodiment in which language is determined according to context may be referred to the above-described related embodiments, and this embodiment will not be repeatedly described herein.

Referring to FIG. 2, Chinese and English each have one vote and the remaining one vote is undecidable, which may be regarded as different votes in the voting results. All votes in the voting result are undecidable or the votes in the voting result are different from each other, the third language identification result determined according to the preset bottom-up strategy may be selected as the target language for playing the sequence number in the speech form.

It should be understood that in some cases, the third language identification result may be undecidable. In order to further enhance the practicality of the present disclosure, when the third language identification result is undecidable, the set default language may be determined as the target language for playing the sequence number in the form of speech, and this is a further bottom-up strategy to avoid the occurrence of a situation that sequence number cannot be played in the form of speech.

Through the above method, the decision-making strategy of the corresponding target language of sequence number is set according to different votes in the voting result, thereby improving the accuracy and reliability of the target language.

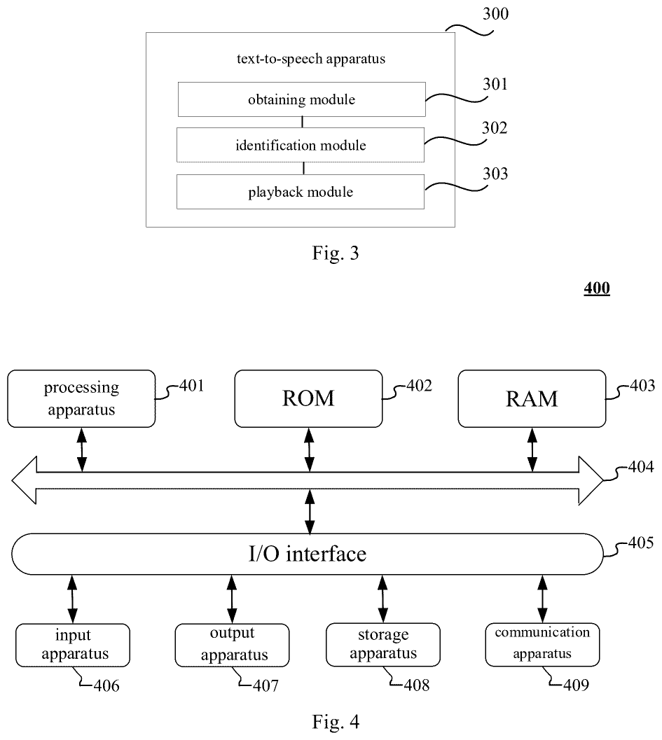

Based on the same concept, the present disclosure provides a text-to-speech apparatus, and FIG. 3 is a block diagram of a text-to-speech apparatus according to an exemplary embodiment of the present disclosure. Referring to FIG. 3, the text-to-speech apparatus may include
an obtaining module 301, configured to obtain chat content, where the chat content includes a first text and a second text output by a dialogue model for the first text, and the second text includes text organized in sequence number;
an identification module 302, configured to identify, according to the first text and the second text, a target language for playing the sequence number in speech form; and
a playback module 303, configured to play the sequence number in speech form with the target language.

In some embodiments, the identification module 302 includes:
a first identification sub-module configured to perform language identification according to the first text to obtain a first language identification result of the sequence number;
a second identification sub-module configured to perform language identification according to the second text to obtain a second language identification result of the sequence number;
a voting sub-module configured to perform a voting operation on language identification results of the sequence number according to the first language identification result and the second language identification result to obtain the target language for playing the sequence number in speech form.

In some embodiments, the first identification sub-module is further configured to:
perform language identification according to target information of the first text to obtain the first language identification result of the sequence number, where the target information includes language information and/or semantic information.

In some embodiments, the second language identification result includes a first sub-language identification result and a second sub-language identification result, and the first identification sub-module is further configured to:
perform language identification according to context before a first sequence number in the second text to obtain the first sub-language identification result of the sequence number; and
perform language identification according to context after the first sequence number in the second text to obtain the second sub-language identification result of the sequence number.

In some embodiments, the language identification result of sequence number includes candidate language or undecidable, and the voting sub-module is further configured to: perform the voting operation on language identification results of the sequence number according to the first language identification result, the first sub-language identification result and the second sub-language identification result to obtain a voting result; and when a vote count of a candidate language in the voting result is greater than or equal to a preset number of votes, determining the candidate language as the target language for playing the sequence number in speech form.

In some embodiments, the voting sub-module is further configured to:
when only one vote in the voting result is the candidate language and all other votes are undecidable, determining the candidate language as the target language for playing the sequence number in speech form.

In some embodiments, the voting submodule is further configured to:
when the voting result satisfies a preset condition, determining a third language identification result determined according to a preset bottom-up strategy as the target language for playing the sequence number in speech form, where the preset condition includes that all votes in the voting result are undecidable or votes in the voting result are different from each other.

The embodiment of each module in the above-described text-to-speech apparatus 300 may refer to the above-described method embodiment, and this embodiment will not be repeatedly described here.

Based on the same inventive concept, embodiments of the present disclosure further provide a computer-readable medium storing a computer program, where the computer program, when executed by a processing apparatus, implements steps of the above method.

Based on the same inventive concept, embodiments of the present disclosure further provide a computer program product including a computer program, where the computer program, when executed by a processor, implements steps of the above method.

Based on the same inventive concept, embodiments of the present disclosure further provide an electronic device, including:
a storage apparatus storing a computer program; and
a processing apparatus configured to performing the computer program in the storage apparatus to implement steps of the above method.

Reference is made to FIG. 4 below, which illustrates a schematic structural diagram of an electronic device 400 suitable for implementing the embodiments of the present disclosure. The terminal device in the embodiments of the present disclosure may include but not be limited to a mobile terminal such as a mobile phone, a notebook computer, a digital broadcast receiver, a personal digital assistant (PDA), a tablet computer (PAD), a portable multimedia player (PMP), a vehicle-mounted terminal (such as vehicle-mounted navigation terminal), and a fixed terminal such as digital a TV, a desktop computer, etc. The electronic device shown in FIG. 4 is only an example, and should not bring any limitation to the functions and scope of use of the embodiments of the present disclosure.

As shown in FIG. 4, the electronic device 400 may include a processing apparatus (e.g., a central processing unit, a graphics processing unit, etc.) 401 that may perform various appropriate actions and processes according to a program stored in a read-only memory (ROM) 402 or a program loaded from a storage apparatus 408 into a random-access memory (RAM) 403. In the RAM 403, various programs and data necessary for the operation of the electronic device 400 are also stored. The processing apparatus 401, the ROM 402, and the RAM 403 are connected to each other through a bus 404. An input/output (I/O) interface 405 is also connected to the bus 404.

Generally, the following apparatuses may be connected to the I/O interface 405: an input apparatus 406 including, for example, a touchscreen, a touchpad, a keyboard, a mouse, a camera, a microphone, an accelerometer, a gyroscope, etc.; an output apparatus 407 including, for example, a liquid crystal display (LCD), a speaker, a vibrator, etc.; the storage apparatus 408 including, for example, a magnetic tape, a hard disk, etc.; and a communication apparatus 409. The communication apparatus 409 may allow the electronic device 400 to perform wireless or wired communication with other devices to exchange data. Although FIG. 4 shows the electronic device 400 having various apparatuses, it should be understood that it is not required to implement or have all of the illustrated apparatuses. More or fewer apparatuses may be implemented or provided alternatively.

In particular, according to the embodiments of the present disclosure, the process described above with reference to the flowchart may be implemented as a computer software program. For example, an embodiment of the present disclosure includes a computer program product, which includes a computer program carried on a non-transitory computer-readable medium, and the computer program includes program codes for executing the method shown in the flowchart. In such an embodiment, the computer program may be downloaded and installed from a network through the communication apparatus 409, or installed from the storage apparatus 408, or installed from the ROM 402. When the computer program is executed by the processing apparatus 401, the above functions defined in the method of the embodiments of the present disclosure are executed.

It should be noted that the above computer-readable medium in the present disclosure may be a computer-readable signal medium, or a computer-readable storage medium, or any combination of the above two. The computer-readable storage medium may be, for example, but not limited to, an electronic, magnetic, optical, electromagnetic, infrared, or semiconductor system, apparatus, or device, or any combination of the above. More specific examples of the computer-readable storage medium may include, but are not limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as part of a carrier wave, and computer-readable program codes are carried therein. This propagated data signal may take many forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit a program for use by or in combination with an instruction execution system, apparatus, or device. The program codes contained on the computer-readable medium may be transmitted by any suitable medium, including but not limited to: a wire, an optical cable, RF (radio frequency), etc., or any suitable combination of the above.

In some implementations, the electronic device may communicate using any currently known or future-developed network protocol, such as HTTP (HyperText Transfer Protocol), and may be interconnected with digital data communication (for example, communication network) in any form or medium. Examples of communication networks include local area networks (“LAN”), wide area networks (“WAN”), international network (for example, the Internet), and end-to-end networks (for example, ad hoc end-to-end networks), as well as any currently known or future-developed networks.

The above computer-readable medium may be included in the above electronic device; or may exist alone without being assembled into the electronic device.

The above computer-readable medium carries one or more programs that, when executed by the electronic device, cause the electronic device to: obtain chat content, where the chat content includes a first text and a second text output by a dialogue model for the first text, and the second text includes text organized in sequence number; identify, according to the first text and the second text, a target language for playing the sequence number in speech form; and play the sequence number in speech form with the target language.

Computer program codes for performing the operations of the present disclosure may be written in one or more programming languages or a combination thereof. The above programming languages include, but are not limited to, object-oriented programming languages such as Java, Smalltalk, C++, and also include conventional procedural programming languages such as “C” language or similar programming languages. The program codes may be executed entirely on a user's computer, partly on a user's computer, as a stand-alone software package, partly on a user's computer and partly on a remote computer, or entirely on a remote computer or a server. In the case of the remote computer, the remote computer may be connected to the user's computer through any kind of network, including a local area network (LAN) or a wide area network (WAN), or may be connected to an external computer (for example, connected through the Internet using an Internet service provider).

The flowcharts and block diagrams in the drawings illustrate possible architecture, function, and operation implementations of the system, method, and computer program product according to various embodiments of the present disclosure. In this regard, each block in the flowcharts or block diagrams may represent a module, a program segment, or a part of codes, and the module, the program segment, or the part of codes contains one or more executable instructions for implementing specified logical functions. It should also be noted that in some alternative implementations, the functions marked in the blocks may also occur in a different order than the order marked in the drawings. For example, two blocks shown in succession may actually be executed substantially in parallel, or may sometimes be executed in a reverse order, which depends on the functions involved. It should also be noted that each block in the block diagrams and/or flowcharts, and the combination of blocks in the block diagrams and/or flowcharts, may be implemented by a dedicated hardware-based system that performs specified functions or operations, or may be implemented by a combination of dedicated hardware and computer instructions.

The modules involved in the embodiments of the present disclosure may be implemented in software or hardware. The name of a module does not constitute a limitation on the module itself under certain circumstances.

The functions described above in this document may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), etc.

In the context of the present disclosure, the machine-readable medium may be a tangible medium that may contain or store a program for use by the instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The above description is only preferred embodiments of the present disclosure and an explanation of the applied technical principles. Those skilled in the art should understand that the scope of disclosure involved in the present disclosure is not limited to the technical solutions formed by the specific combination of the above technical features, but also covers other technical solutions formed by any combination of the above technical features or their equivalent features without departing from the above disclosed concept, for example, a technical solution formed by replacing the above features with technical features with similar functions disclosed in the present disclosure (but not limited to).

In addition, although the operations are described in a particular order, this should not be understood as requiring that the operations be performed in the particular order shown or in a sequential order. Under certain circumstances, multitasking and parallel processing may be advantageous. Likewise, although several specific implementation details are included in the above discussion, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments, either individually or in any suitable sub-combination.

Although the present subject matter has been described in language specific to structural features and/or logical actions of the method, it should be understood that the subject matter defined in the appended claims is not necessarily limited to the specific features or actions described above. Rather, the specific features and actions described above are merely exemplary forms for implementing the claims.

1. A method of text-to-speech, comprising:
obtaining chat content, wherein the chat content comprises a first text and a second text output by a dialogue model for the first text, and the second text comprises text organized in sequence number;
identifying, according to the first text and the second text, a target language for playing the sequence number in speech form; and
playing the sequence number in speech form with the target language.

2. The method according to claim 1, wherein the identifying, according to the first text and the second text, the target language for playing the sequence number in speech form comprises:
performing language identification according to the first text to obtain a first language identification result of the sequence number;
performing language identification according to the second text to obtain a second language identification result of the sequence number; and
performing a voting operation on language identification results of the sequence number according to the first language identification result and the second language identification result to obtain the target language for playing the sequence number in speech form.

3. The method according to claim 2, wherein the performing language identification according to the first text to obtain the first language identification result of the sequence number comprises:
performing language identification according to target information of the first text to obtain the first language identification result of the sequence number, wherein the target information comprises language information and/or semantic information.

4. The method according to claim 2, wherein the second language identification result comprises a first sub-language identification result and a second sub-language identification result, and the performing language identification according to the second text to obtain the second language identification result of the sequence number comprises:
performing language identification according to context before a first sequence number in the second text to obtain the first sub-language identification result of the sequence number; and
performing language identification according to context after the first sequence number in the second text to obtain the second sub-language identification result of the sequence number.

5. The method according to claim 4, wherein the language identification result of the sequence number comprises candidate language or undecidable, and the performing the voting operation on language identification results of the sequence number according to the first language identification result and the second language identification result to obtain the target language for playing the sequence number in speech form, comprises:
performing the voting operation on language identification results of the sequence number according to the first language identification result, the first sub-language identification result and the second sub-language identification result to obtain a voting result; and
when a vote count of a candidate language in the voting result is greater than or equal to a preset number of votes, determining the candidate language as the target language for playing the sequence number in speech form.

6. The method according to claim 5, wherein the performing the voting operation on language identification results of the sequence number according to the first language identification result and the second language identification result to obtain the target language for playing the sequence number in speech form, further comprises:
when only one vote in the voting result is the candidate language and all other votes are undecidable, determining the candidate language as the target language for playing the sequence number in speech form.

7. The method according to claim 5, wherein the performing the voting operation on language identification results of the sequence number according to the first language identification result and the second language identification result to obtain the target language for playing the sequence number in speech form, further comprises:
when the voting result satisfies a preset condition, determining a third language identification result determined according to a preset bottom-up strategy as the target language for playing the sequence number in speech form, wherein the preset condition comprises that all votes in the voting result are undecidable or votes in the voting result are different from each other.

8. A electronic device comprising:
a storage apparatus storing a computer program; and
a processing apparatus configured to performing the computer program in the storage apparatus to implement steps of a method of text-to-speech, wherein the method comprises:
obtaining chat content, wherein the chat content comprises a first text and a second text output by a dialogue model for the first text, and the second text comprises text organized in sequence number;
identifying, according to the first text and the second text, a target language for playing the sequence number in speech form; and
playing the sequence number in speech form with the target language.

9. The electronic device according to claim 8, wherein the identifying, according to the first text and the second text, the target language for playing the sequence number in speech form comprises:
performing language identification according to the first text to obtain a first language identification result of the sequence number;
performing language identification according to the second text to obtain a second language identification result of the sequence number; and
performing a voting operation on language identification results of the sequence number according to the first language identification result and the second language identification result to obtain the target language for playing the sequence number in speech form.

10. The electronic device according to claim 9, wherein the performing language identification according to the first text to obtain the first language identification result of the sequence number comprises:
performing language identification according to target information of the first text to obtain the first language identification result of the sequence number, wherein the target information comprises language information and/or semantic information.

11. The electronic device according to claim 9, wherein the second language identification result comprises a first sub-language identification result and a second sub-language identification result, and the performing language identification according to the second text to obtain the second language identification result of the sequence number comprises:
performing language identification according to context before a first sequence number in the second text to obtain the first sub-language identification result of the sequence number; and
performing language identification according to context after the first sequence number in the second text to obtain the second sub-language identification result of the sequence number.

12. The electronic device according to claim 11, wherein the language identification result of the sequence number comprises candidate language or undecidable, and the performing the voting operation on language identification results of the sequence number according to the first language identification result and the second language identification result to obtain the target language for playing the sequence number in speech form, comprises:
performing the voting operation on language identification results of the sequence number according to the first language identification result, the first sub-language identification result and the second sub-language identification result to obtain a voting result; and
when a vote count of a candidate language in the voting result is greater than or equal to a preset number of votes, determining the candidate language as the target language for playing the sequence number in speech form.

13. The electronic device according to claim 12, wherein the performing the voting operation on language identification results of the sequence number according to the first language identification result and the second language identification result to obtain the target language for playing the sequence number in speech form, further comprises:
when only one vote in the voting result is the candidate language and all other votes are undecidable, determining the candidate language as the target language for playing the sequence number in speech form.

14. The electronic device according to claim 12, wherein the performing the voting operation on language identification results of the sequence number according to the first language identification result and the second language identification result to obtain the target language for playing the sequence number in speech form, further comprises:
when the voting result satisfies a preset condition, determining a third language identification result determined according to a preset bottom-up strategy as the target language for playing the sequence number in speech form, wherein the preset condition comprises that all votes in the voting result are undecidable or votes in the voting result are different from each other.

15. A computer-readable medium storing a computer program, wherein the computer program, when executed by a processing apparatus, implements steps of a method of text-to-speech, wherein the method comprises:
obtaining chat content, wherein the chat content comprises a first text and a second text output by a dialogue model for the first text, and the second text comprises text organized in sequence number;
identifying, according to the first text and the second text, a target language for playing the sequence number in speech form; and
playing the sequence number in speech form with the target language.

16. The computer-readable medium according to claim 15, wherein the identifying, according to the first text and the second text, the target language for playing the sequence number in speech form comprises:
performing language identification according to the first text to obtain a first language identification result of the sequence number;
performing language identification according to the second text to obtain a second language identification result of the sequence number; and
performing a voting operation on language identification results of the sequence number according to the first language identification result and the second language identification result to obtain the target language for playing the sequence number in speech form.

17. The computer-readable medium according to claim 16, wherein the performing language identification according to the first text to obtain the first language identification result of the sequence number comprises:
performing language identification according to target information of the first text to obtain the first language identification result of the sequence number, wherein the target information comprises language information and/or semantic information.

18. The computer-readable medium according to claim 16, wherein the second language identification result comprises a first sub-language identification result and a second sub-language identification result, and the performing language identification according to the second text to obtain the second language identification result of the sequence number comprises:
performing language identification according to context before a first sequence number in the second text to obtain the first sub-language identification result of the sequence number; and
performing language identification according to context after the first sequence number in the second text to obtain the second sub-language identification result of the sequence number.

19. The computer-readable medium according to claim 18, wherein the language identification result of the sequence number comprises candidate language or undecidable, and the performing the voting operation on language identification results of the sequence number according to the first language identification result and the second language identification result to obtain the target language for playing the sequence number in speech form, comprises:
performing the voting operation on language identification results of the sequence number according to the first language identification result, the first sub-language identification result and the second sub-language identification result to obtain a voting result; and
when a vote count of a candidate language in the voting result is greater than or equal to a preset number of votes, determining the candidate language as the target language for playing the sequence number in speech form.

20. The computer-readable medium according to claim 19, wherein the performing the voting operation on language identification results of the sequence number according to the first language identification result and the second language identification result to obtain the target language for playing the sequence number in speech form, further comprises:
when only one vote in the voting result is the candidate language and all other votes are undecidable, determining the candidate language as the target language for playing the sequence number in speech form.
